(19) United States
(12) Patent Application Publication
(10) Pub. No.: US 2024/0019710 A1
(43) Pub. Date: Jan. 18, 2024

(54) OPTICAL SYSTEM FOR A VIRTUAL RETINAL SCAN DISPLAY AND METHOD FOR PROJECTING IMAGE CONTENTS ONTO A RETINA

(71) Applicant: Robert Bosch GmbH, Stuttgart (DE)

(72) Inventors: Andrea Marchini, Kusterdingen (DE); Andreas Petersen, Eningen (DE); Christian Nitschke, Kusterdingen (DE); Eva Lea Elisabeth Empting, Kuesnacht (CH); Gael Pilard, Wankheim (DE); Hendrik Specht, Pliezhausen (DE); Joerg Carls, Altdorf (DE); Johannes Hofmann, Tuebingen (DE); Maximilian Busch, Eningen Unter Achalm (DE); Sebastian Reiss, Reutlingen (DE); Simon Pick, Tuebingen (DE); Tadiyos Alemayehu, Pfullingen (DE); Thomas Kuenstle, Reutlingen (DE)

(21) Appl. No.: 18/255,531

(22) PCT Filed: Oct. 18, 2021
(86) PCT No.: PCT/EP2021/078731

§ 371 Date: Jun. 1, 2023

(30) Foreign Application Priority Data
Feb. 1, 2021 (DE) 10 2021 200 893.3

(51) Int. Cl. G02B 27/18; G02B 27/01; G02B 27/00

(52) U.S. Cl. CPC G02B 27/18; G02B 27/0172; G02B 27/0093; G02B 27/0025; G02B 2027/0178

(57) ABSTRACT

An optical system for a virtual retinal scan display. The system includes: an image source providing image content as image data; an image-processing device; a projector unit for generating at least one light beam, and having a controllable deflecting device for the at least one light beam for the scanning projection of the image content; a diverting unit, onto which the image content is projected, equipped to direct the projected image content onto an eye of a user; an optical segmentation element using which the image content is projectable via different imaging paths onto at least one projection region of the diverting unit, at least individual imaging paths being controllable individually; and an optical replication component equipped to direct the projected image content, replicated and spatially offset, onto the eye of the user, so that a plurality of mutually spatially offset exit pupils having the image content is produced.

### BACKGROUND INFORMATION

Smart glasses having retinal scan displays are described in the related art.

### SUMMARY

According to the present invention, an optical system for a virtual retinal scan display is provided. According to an example embodiment of the present invention, the optical system includes
a. an image source which provides an image content in the form of image data,
b. an image-processing device for the image data,
c. a projector unit having a light source, able to be temporally modulated, for generating at least one light beam, and having a deflecting device, controllable particularly by the projector unit, for the at least one light beam for the scanning projection of the image content,
d. a diverting unit onto which the image content is able to be projected and which is equipped to direct the projected image content, preferably at least a portion of the total intensity of the projected image content, onto an eye of a user,
e. an optical segmentation element, positioned between the projector unit and the diverting unit, with whose aid the image content is projectable via different imaging paths onto at least one projection region of the diverting unit, at least individual imaging paths being controllable individually, and
f. an optical replication component which is disposed in the at least one projection region of the diverting unit and is equipped to direct the projected image content, replicated and spatially offset, onto the eye of the user, so that a plurality of mutually spatially offset exit pupils having the image content is produced.

Functionality of the virtual retinal scan display may be improved beneficially, thanks to the design of the optical system according to the present invention. Advantageously, a particularly large effective total eyebox may be attained, which notably at the same time has a largest possible field of vision. An “effective total eyebox” is to be understood particularly as a spatial area at pupil positions of a user eye in which the entire image content comes from at least one exit pupil (eyebox) of the virtual retinal scan display (RSD) through the pupil of the user eye. Particularly great tolerance may thus be achieved beneficially with respect to eye movements and/or with respect to slipping of smart glasses of the optical system. Particularly comfortable usage of the smart glasses may thus be attained advantageously. In addition, attainment of an especially large effective total eyebox advantageously makes it possible to cover a large range of inter-pupil distances for different users (“one-size-fits-all”). The optical system may be formed to be free beneficially from what is referred to as dynamic eyebox control, which varies a position of one or more exit pupils in the eye-pupil area, particularly adjusts it as a function of an eye tracker of an eye movement of the user eye. This permits a favorable reduction in complexity, energy consumption and/or costs.

A “virtual retinal scan display” is to be understood specifically as a retinal scan display or a light field display in which the image content is scanned sequentially by deflection of at least one light beam, especially a laser beam of at least one temporally modulated light source such as one or more laser diodes, for example, and imaged through optical elements directly onto the retina of the user eye. In particular, the image source is in the form of an electronic image source, e.g., a graphics output, especially an (integrated) graphics card, of a computer or processor. For instance, the image source may be formed integrally with the image-processing device of the optical system. Alternatively, the image source may be formed separately from the image-processing device and transmit image data to the image-processing device of the optical system. In particular, the image data are in the form of color-image data, e.g., RGB image data. The image data may especially be in the form of inanimate or moving images, e.g., videos. The image-processing device is provided preferably to modify, particularly to distort, copy, rotate, offset, scale or the like, the image data of the image source. The image-processing device is provided preferably to generate copies of the image content, which in particular are modified, e.g., distorted, rotated, offset and/or scaled.

According to an example embodiment of the present invention, the projector unit is equipped particularly to emit the image content from the image data in the form of scanned and/or rasterized light beams. In particular, the projector unit includes a deflecting device, preferably an MEMS mirror (micro-mirror actuator), at least for the controlled deflection of the at least one light beam of the light source of the projector unit. Alternatively or additionally, the deflecting device includes at least one switchable diffractive-optical element in the form of a phase modulator and/or intensity modulator which may be realized, for example, as a spatial light modulator (SLM) in reflective type of construction, e.g., in DMD (digital micro-mirror device) or LCoS (liquid crystal on silicon) type of construction or in transmittive type of construction, e.g., as an LCD. In particular, the temporally modulable light source is modulated in analog fashion, however, an alternative TTL (transistor-transistor logic) modulation also not being ruled out, for example. The diverting unit specifically includes a configuration of optical elements, e.g., diffractive, reflective, refractive and/or holographic optical elements. In this context, however, the diverting unit preferably always includes at least one holographic optical element. The diverting unit is integrated at least partially into a lens of a pair of smart glasses. Specifically, the diverting unit is provided to divert only a portion of the intensity of the projected image content onto the user eye. At least a further portion of the intensity of the projected image content passes through the diverting unit. Viewed at least from a perpendicular viewing direction, the diverting unit appears essentially transparent for a user. In particular, the diverting unit forms a projection region. Namely, the projection region forms an area within which a light beam, upon striking the diverting unit, is deflected/diverted in the direction of the user eye, especially in the direction of an eye-pupil area of the optical system. “Provided” and/or “equipped” are to be understood particularly as specially programmed, designed and/or outfitted. The statement that an object is provided and/or equipped for a specific function is to be understood especially to the effect that the object fulfills and/or carries out this specific function in at least one application state and/or operating state.

The optical segmentation element is positioned preferably in a beam path of the scanned light beam between the deflecting device of the projector unit and the diverting unit. In particular, the optical segmentation element may take the form of a spatially segmented optical element which is provided specifically to spatially separately image/redirect a spatial segmentation of individual sub-images of the image data. The optical segmentation element may especially take the form of a temporally segmenting optical element. Good spatial resolution of the imagings may be achieved expediently in this manner. Advantageously, a spatial resolution and/or a visual field of the original image content is retained, at least for the most part, during the temporal segmentation. To achieve the temporal segmentation, for example, the light beam may be split sequentially into temporally successive partial beams by a temporally segmenting optical element in the form of a controlled beam splitter. Alternatively, the light beam could be influenced by a temporally segmenting optical element in the form of an uncontrolled beam splitter in which a controllable optical shutter system is downstream of each generated partial beam, in such a way that all except for one partial beam of the beam splitter are always blocked sequentially by the shutter system. In both cases, the output of the image data, especially the modified output of the image data by the image-processing device, is matched in each instance synchronously with opening intervals of the shutters of the shutter system in such a way that at any point in time, in each case only the image content is sent on the way to the diverting unit which belongs to the imaging path of the shutter presently open and is adapted/modified accordingly. In addition, it is possible that spatially segmenting optical elements and temporally segmenting optical elements are combined with each other. For example, in a combination of temporal and spatial segmentation, spatial segmentation is carried out along one image direction, and temporal segmentation is carried out along a second image direction orthogonal to it. In that case, advantageously that direction is segmented temporally which is limited more by its spatial resolution. A highest possible spatial resolution of the imagings may be achieved advantageously in this manner. In particular, the temporal segmentation, i.e., especially the switching of the beam splitter, may be carried out with a high frequency, so that the inertia of the user eye perceives a continuous flicker-free image. Alternatively, a non-periodic switching of the shutters and the modification of the image content may also be provided, which specifically is dependent on a pupil position of the user eye. In this case, for example, the shutters (i.e., the individual imaging paths) are switched in reaction to a movement of the user eye. In particular, in the case of the temporal segmentation, at any point in time only a portion (corresponds to the number of generated replications) of the exit pupils of all possible exit pupils of the optical system actually has an imaging, which, however, is not perceivable for the sluggish user eye.

The optical segmentation element is provided particularly to generate a plurality of different imaging paths. Namely, the segmentation element is provided to generate a number of different imaging paths which corresponds to a number of segmentations/segments of the optical segmentation element. Preferably, after being diverted by the diverting unit, each of the different imaging paths leads/passes into one exit pupil disposed separately from all other exit pupils. Particularly in the case of the spatial segmentation, the light beams of each imaging path are diverted within (possibly partially overlapping) sections of the projection region differing from each other. Particularly in the case of the temporal segmentation, the light beams of each imaging path of an at least essentially identical section of the projection region, which preferably includes at least a large portion of the total projection region, are diverted. The statement that “individual imaging paths are controllable individually” is to be understood particularly to the effect that a form/modification/distortion of an image content/image segment (sub-image data) transmitted via a certain imaging path and/or an activity (“on/off”) of the image content/image segment (sub-image data) is controllable individually. It is possible that the optical system has a control- or automatic control unit for the individual control of the imaging paths. A “control- or automatic control unit” is to be understood specifically as a unit having at least one electronic control system. An “electronic control system” is to be understood namely as a unit having a processor unit and having a memory unit, as well as an operating program stored in the memory unit. In particular, the control- or automatic control unit may be integrated into the smart glasses, e.g., into an earpiece of the smart glasses, or may be formed separately from the smart glasses, e.g., as part of an external device such as a smart phone assigned to the optical system. In addition, it is possible for the control- and/or automatic control unit to be formed at least partially in one piece with the image-processing device or with the projector unit. The statement that two units are formed “partially in one piece” is to be understood, namely, to the effect that the units have at least one, especially at least two, advantageously at least three elements in common which is/are components, particularly functionally important components, of both units. In particular, it is possible that the individual imaging paths are controlled in open and/or closed loop based on instantaneous measuring results of a changeable surroundings situation, for example, based on measuring results of an eye-tracker device or the like, preferably online and/or virtually in real time.

An optical replication component is to be understood, namely, as a component of the optical system including optical elements, which generates a spatially offset optical replication of a projected image content. In particular, the optical replication component forms at least one part of the diverting unit. The optical replication component is provided especially to replicate all image contents projected via the individual imaging paths of the optical segmentation element. The optical replication component is provided particularly to generate a number of exit pupils that corresponds to a multiple (e.g., double, triple, etc.) a number of segmentations performed by the optical segmentation element. In particular, in this context, a number of exit pupils (e.g., two, three, etc.), which corresponds to a number of replications performed by the optical replication component, in each instance includes (constantly) identical image contents, especially identically modified, identically distorted or identically blanked image contents. In particular, at least centers of the exit pupils are offset spatially relative to each other. Specifically, the exit pupils of the plurality of mutually spatially offset exit pupils lie in one common eye-pupil area. The common eye-pupil area essentially forms one common eye-pupil plane, deviations from a perfect plane, e.g., due to rotary eye movements, etc., being disregarded. Namely, the eye-pupil area (eye-pupil plane) is formed as an area (plane) of the optical system, preferably of the smart glasses, in which the pupils of the user of the optical system are located more or less (ideally) during use of the optical system by the user. In particular, the eye-pupil area (eye-pupil plane) runs approximately parallel to a surface of a lens of the smart glasses, especially approximately parallel to a surface of a part of the lens of the smart glasses reflecting the light beams. An “exit pupil” is to be understood namely as an image-side image of a (virtual) aperture stop of the optical component of the optical system generating the imaging of the image content. During an intended use of the optical system, in particular, at least one of the exit pupils of the optical system overlaps with an entrance pupil of the user eye. During the intended use of the optical system, advantageously at least two exit pupils of the optical system always overlap simultaneously with the entrance pupil of the user eye. In particular, the image content (that is, the respective imaging of the image content) located preferably in a (virtual) entrance pupil of the optical component of the optical system, is imaged in the exit pupil. Specifically, each exit pupil of the optical system forms an eyebox. Notably, each of the exit pupils includes an imaging of the image content. In particular, the optical system has at least two, preferably at least four, advantageously at least six, preferably at least nine and, especially preferred, more than ten exit pupils, each of which includes, namely, the image content or an imaging of the image content, especially a copy or a version of the image content. A “copy of the image content” is to be understood specifically as an exact or virtually exact imaging of the respective image content. A “version of the image content” is to be understood particularly as an altered, especially at least distorted, offset, rotated or otherwise scaled imaging of the image content. In particular, the exit pupils are disposed without overlapping each other. A “spatial segmentation” of an image is to be understood particularly as a separating of the image into multiple individual or sub-images which preferably include copies or versions of the image content and which are disposed, spatially separate from one another, in one image plane, especially side-by-side and/or one above the other. A “temporal segmentation” of an image is to be understood particularly as a separating of the image into a sequence of multiple individual images or sub-images temporally separated from each other, particularly represented one after the other in time, which preferably contain copies or versions of the image content. A “replication” of an image is to be understood particularly as an at least essentially identical multiplication of the (unmodified or modified) image, preferably in at least a 1:1 reproduction of the image, disposed spatially separate with respect to the image. In particular, the image produced by replication is generated by optical elements of the optical system, which are different from segmented or segmenting optical elements of the optical system.

In addition, it is proposed that the image-processing device be equipped to generate sub-image data from the image data of the image source in order to control the projector unit, the sub-image data permitting the image content to be projected via at least two different imaging paths of the individually controllable imaging paths onto at least one projection region of the diverting unit, and that the image-processing device be equipped to generate different sub-image data for the at least two different imaging paths, so that a distortion of the image content produced, e.g., by the optical elements of the optical system (optical segmentation element and/or optical replication component), is at least partially, preferably to a great extent, preferentially virtually completely compensated for via the respective imaging path. Advantageously, a particularly large effective total eyebox may thus be attained, which notably at the same time has a largest possible field of vision, that moreover is beneficially free of double images. The sub-image data especially include copies or (distorted, offset, rotated or otherwise scaled) versions of the image content. The image-processing device is equipped particularly to generate sub-image data with sequentially successive individual sub-images, that in each case are modified (temporal segmentation) for different imaging paths. Alternatively or additionally, the image-processing device is equipped to generate sub-image data that in each case include multiple sub-images displayed simultaneously, each of the sub-images of the sub-image data being modified separately (spatial segmentation) for different imaging paths. In particular, each sub-image of the sub-image data is projected via a different (separate) imaging path of the individually controllable imaging paths onto the projection region of the diverting unit. The statement that a distortion of the image content is compensated for is to be understood in particular to the effect that the sub-image data are modified in such a way that after transiting all optical elements of the optical system, the light beams which reach the user eye produce an image impression there for the user which corresponds at least for the most part to the original (undistorted) image content. The distortion of the sub-images or the sub-image data is intended specifically to compensate for and/or offset a distortion produced by the optical elements of the optical system.

In particular, the sub-image data and/or the sub-images are in each case adapted by the control- or automatic control unit, preferably in combination with the image-processing device and/or with the projector unit, in such a way that beams arriving at the eye from different exit pupils at the same angle contain identical imagings. Namely, to that end, different specific geometric and/or radiometric parameterizations of the image data are produced for different imaging paths, e.g., by a digital image-data correction, preferably by a digital image modification (image distortion, etc.), which are intended specifically to “rectify” the imagings of the image content, projected particularly onto the retina of the user eye, so that advantageously the imagings of all exit pupils entering into the user eye are superimposed relative to each other in one replica. The parameterization/the image modification is dependent particularly on the form of the optical system and/or environmental conditions such as temperature, etc. In particular, the parameterization/the image modification is determined one time in a calibration step (e.g., during production of the virtual retinal scan display). In addition, it is possible that the parameterization/the image modification is adapted to dynamic system parameters such as temperature, deformation and/or general superimposition errors during usage of the virtual retinal scan display. Preferably, a normal-sighted user eye having an eye lens accommodated to infinity images parallel beams with identical image content onto one common image point on the retina of the user eye. A totality of all image points produced on the retina of the user eye by the light beams of all exit pupils entering into the entrance pupil of the user eye yields a single sharp total image. Due to the appropriate parameterization, particularly image modification (e.g., distortion, etc.) of the individual imagings, an image content of this total image advantageously remains geometrically constant, even if, to the accompaniment of translatory and/or rotary eye movement and/or change in pupil size, a share of individual exit pupils of the set of exit pupils produced by the optical system in the eye-pupil area, changes in the light-beam bundle coming through the pupil at a point in time. In particular, it is necessary to avoid the circumstance where beams of multiple exit pupils, produced by replication, which originate from identical sub-images, arrive through the pupil of the user eye at the same time, and as a consequence, multiple images not able to be parameterized/modified independently of each other strike the retina of the user eye and thus produce images not lying one upon the other on the retina.

In addition, it is proposed that the image-processing device be equipped to generate sub-image data from the image data of the image source, which permit a simultaneous projection of N×M sub-images having at least essentially the same image content, and that the optical segmentation element perform a spatial segmentation, so that the at least essentially identical image content of the N×M sub-images is projected via at least two different imaging paths of the individually controllable imaging paths onto the at least one projection region of the diverting unit. Advantageously, a particularly large effective total eyebox may thus be attained, which notably at the same time has a largest possible field of vision, that moreover is beneficially free of double images. In particular, the sub-image data in this case include N*M sub-images. To be understood by the expression “essentially identical image content” is an image content that, apart from the modifications of the individual sub-images carried out to compensate for the distortions produced by the optical elements of the optical system, is identical in comparison to the image content to be displayed. In particular, N in this context is an integer number greater than or equal to 1. In particular, M in this context is an integer number greater than or equal to 1.

In addition, it is proposed that the image-processing device be equipped to switch individual imaging paths to active by making the sub-image data for the corresponding sub-image available for controlling the projector unit, and to switch off individual imaging paths by blanking the sub-image data for the corresponding sub-images. Copies of a sub-image that are optically identical but shifted spatially relative to each other in the eye-pupil area are thereby prevented favorably from being visible simultaneously for the user. Advantageously, a particularly large effective total eyebox may thus be attained, which notably at the same time has a largest possible field of vision, that moreover is beneficially free of double images. In particular, each sub-image of the sub-image data is able to be modified, activated and/or deactivated (blanked) individually and/or separately.

In addition, it is proposed that the optical segmentation element be realized in the form of a segmenting lens, a segmenting mirror, a segmenting optical diffraction grating or volume hologram or a beam splitter. A simple and/or effective optical segmentation may be achieved advantageously in this manner. A high number of exit pupils and therefore a large effective total eyebox may thus be achieved advantageously. The segmenting lens preferably takes the form of a segmented lens, especially a segmented transmission lens. The segmenting mirror is preferably in the form of a segmented mirror. The segmenting diffraction grating is preferably in the form of a segmented diffraction grating. In particular, the respective optical segmentation element has P individual segments, each individual segment preferably producing Q imagings of the image content, Q being given as a number of replications carried out by the optical replication component. Namely, the optical system thus produces P*Q imagings and/or exit pupils disposed separately from each other.

In this connection, it is stressed especially that a beam splitter is usable for the spatial segmentation, even without use of an optical switch element downstream of the beam splitter. Namely, to that end, the beam splitter is designed in such a way that beam cones produced by the beam splitter are shifted so far in angle with respect to each other that the beam cones only partially overlap on the projection region of the diverting unit (in the case of 2 segments, for example, half, the other halves would then project laterally beyond the projection region). If, in the exemplary case with two segments, a left side of the one beam cone overlaps with a right side of the other beam cone (both beam cones are copies of each other and have exactly the same image content), then by switching off one half of the two beam cones, the overlap region would receive only the image information of the other beam cone, which comes from a first angular range and vice versa.

Furthermore, it is proposed that the optical segmentation element be realized in the form of a beam-splitter assembly which multiplies the projected image content N×M-fold, so that the image content is able to be projected on N×M different imaging paths onto at least one projection region of the diverting unit, that the beam splitter be assigned at least one optical switch element with which at least a portion of the imaging paths is switchable either to active or inactive (temporal segmentation), and that the image-processing device be equipped to generate sub-image data for controlling the projector unit from the image data of the image source, so that a distortion of the image content is compensated for at least to some extent via the at least one imaging path switched to active. Good spatial resolution of the imagings may be achieved advantageously in this manner. A spatial resolution and/or a visual field of the original image content is advantageously retained at least for the most part during the temporal segmentation. In particular, N in this context is an integer number greater than or equal to 1. In particular, M in this context is an integer number greater than or equal to 1. The beam splitter may assume various forms. Thus, for example, in order to generate 2×2 individually switchable imaging paths, two separate 2×1 beam splitters may be series-connected, or one integrated 2×2 beam splitter may be used which splits the optical beam into 4 beams in a single optical component. The use of one beam splitter also has the advantage that resulting output-image channels for the exit pupils may be directed in different geometric directions in order, namely, to thus facilitate the most suitable possible guidance of the image channels from the standpoint of the overall system (minimizing costs, space required) and/or in order to strike the optical replication component (e.g., a HOE (holographic optical element)) at the most ideal angles possible (if necessary, not parallel to each other), in order to be able to be directed as well as possible from there into the respective exit pupil. In addition, an arriving image channel does not necessarily have to strike the beam splitter in a direction perpendicular to it, but rather, notably, may also strike the beam splitter at an acute or obtuse angle, so that great compactness may be attained advantageously. In turn, the closer the beam splitter is to the projector unit, the smaller the beam splitter may be.

In addition, it is proposed that the optical switch element be realized as a component of the beam-splitter assembly or as a separate filter element able to be positioned in the output-beam path of the beam-splitter assembly. A simple and/or effective temporal segmenting may be achieved advantageously in this manner. In particular, the optical system has an optical switch element for each partial beam of the above-mentioned beam splitter. Notably, the respective partial beam is able to be blocked up to (nearly) 100% by the optical switch element. In particular, the optical switch elements are switchable between nearly total (100%) transmission and nearly totally suppressed (0%) optical transmission.

In this context, if the optical switch element is realized in the form of an electrically controllable (optical) polarization filter and or an electro-optical modulator and/or an acousto-optical modulator and/or a photo-elastic modulator and/or an optical shutter and/or an electrically controllable liquid lens, this advantageously permits an effective switching of the partial beams at the output of the beam splitter. The optical switch elements may be formed as polarization filters introduced separately into the optical image channels, as independent optical elements, as integral parts of the beam-splitter assembly (e.g., switchable coatings). The optical switch elements preferably have a changeable speed with which it is possible to change between full switch-on and switch-off and which is selected in such a way that a sluggishness of the user eye may be utilized and/or which is selected according to a dynamic requirement of the overall system (eye movement from exit pupil to exit pupil). In particular, the optical switch element has the above-mentioned switching properties (switchover between almost 0% and almost 100% transmission) for the visible spectral range, preferably for a spectral range between at least 440 nm and 670 nm, preferentially for a spectral range between at least 450 nm and 640 nm, and especially preferred, for a spectral range between at least 460 nm and 620 nm. In particular, the optical switch element also has the corresponding switching properties (switchover between nearly 0% and nearly 100% transmission) for light beams which strike the optical switch element at a non-perpendicular angle. The electrically controllable polarization filter is equipped specifically with the ability to switch a linearly polarized (laser-) light of the projection unit on and off, e.g., on the basis of liquid crystals. The electro-optical modulator is equipped particularly to influence the phase, amplitude and/or polarization of the light beams, like non-linear optical materials, for example, whose refractive indices are dependent on the local electric field, but also electrically induced double refraction (Pockels effect, Kerr effect). The acousto-optical modulator is equipped specifically to produce an optical diffraction grating for the diffraction of light in a material by tunable (ultra-) sonic waves, e.g., with the aid of piezo actuators. The photo-elastic modulator is equipped particularly to modulate optical properties, especially refractive indices, by mechanical deformation, e.g., with the aid of piezo actuators. In particular, the electrically controllable liquid lens is in the form of an optical lens based on liquid lens technology, in which a (transparent or opaque) liquid within a lens cell is pumped electrically in and out to thus alter the optical transparency, that is, to act as an optical switch element. In this case, the electrically controllable liquid lens may be designed specifically in such a way that incident light beams are refracted (refractive power>0, focal length<∞), or that incident light beams pass through the electrically controllable liquid lens essentially unrefracted (refractive power≈0, focal length=∞). In one design free of a refractive power, the electrically controllable liquid lens may be understood particularly as a type of electrically controllable liquid shutter, which is based on the same technology as the electrically controllable liquid lens.

It is further proposed that the optical replication component be realized in a layer structure having at least one holographically functionalized layer, preferably having at least two holographically functionalized layers. A simple and/or effective optical replication may be achieved expediently in this manner. An especially high number of exit pupils and therefore an especially large effective total eyebox may thus be achieved advantageously. In particular, one (unreplicated) set of exit pupils (eyebox set), especially of all image data (sub-images) imaged via individually switchable imaging paths is produced by a first holographically functionalized layer of the optical replication component. In particular, a replication of the entire set of exit pupils, especially of all image data (sub-images) imaged via individually switchable imaging paths is produced by each further holographically functionalized layer in addition to the first holographically functionalized layer of the optical replication component. Specifically, upon each replication of a set of exit pupils, especially each of the image data (sub-images) imaged via individually switchable imaging paths, a spatially and/or angularly shifted copy of the original image regions, particularly of the (unreplicated) set of exit pupils, preferably of the image data (sub-images) imaged via individually switchable imaging paths, is produced. In particular, it is also possible that only a portion of the exit pupils of an (unreplicated) set of exit pupils is replicated by the further holographically functionalized layers in addition to the first holographically functionalized layer of the optical replication component, for example, when an area extension of the two holographically functionalized layers of the optical replication component is different. Notably, it is possible that the optical replication component has at least three or more holographically functionalized layers.

In particular, each of the holographically functionalized layers is partially reflecting and partially transparent. Specifically, the optical replication is produced in that in each case, the same image information, especially the same light beam is deflected differently twice, e.g., in two different angular directions, by two holographically functionalized layers of the optical replication component, and thus intersects the eye-pupil area at two different points. In particular, a pattern or an arrangement of exit pupils in the eye-pupil area is able to be replicated, preferably is able to be multiplied by the optical replication component in the vertical direction and/or in the horizontal direction and or in directions at an angle relative to the vertical direction/horizontal direction.

If the holographically functionalized layers of the optical replication component are in the form of reflecting (e.g., reflection holograms) and/or transmitting (e.g., transmission holograms) holographic optical elements (HOEs), an especially advantageous replication is able to be achieved. Namely, different HOEs may have different optical functions which expressly produce a different deflection of impinging light beams (e.g., thanks to one formation of reflection holograms, the light beams reflect like concave mirrors or convex mirrors). In particular, each HOE is formed of a holographic material, e.g., a photopolymer or a silver halide. In particular, in each case at least one holographic optical function is written into the holographic material for each HOE. In particular, in each case at least one holographic optical function including multiple wavelengths is written into the holographic material for each HOE. In particular, in each case at least one holographic optical function including RGB wavelengths is written into the holographic material for each HOE.

In addition, it is proposed that the optical replication component be realized in a layer structure having at least two layers disposed one above the other with different holographic functions, thus producing the plurality of exit pupils offset spatially relative to each other. In this way, an advantageous replication of images may be achieved, which is able to be produced particularly cost-effectively and/or easily. In particular, the layers having different holographic functions are disposed layer-wise one after the other in a direction running at least essentially perpendicular to the eye-pupil area, preferably in an intended viewing direction toward the optical replication component. In particular, the optical replication component is integrated into at least one lens of the smart glasses. It is possible for the optical replication component to extend only over a portion of the lens or over the entire lens. In particular, the optical replication component exhibits a transparency high enough, that it appears transparent for someone wearing the smart glasses. The holographically functionalized layers may be of different size, however the holographic material layers preferably overlapping completely or nearly completely from the intended viewing direction toward the optical replication component. The holographically functionalized layers may abut directly against each other or may be separated from each other by a (transparent) intermediate layer. It is possible for the holographic functions of the various holographically functionalized layers to be formed to deflect different wavelengths (e.g., one holographic layer per influenced wavelength), however, the holographic functions of the various holographically functionalized layers are formed preferably to deflect the same RGB wavelengths.

If, alternatively, the optical replication component includes at least one layer in which at least two different holographic functions are realized, the different holographic functions being formed in one common plane but in different intermittent zones of the layer, and thus the plurality of exit pupils offset spatially relative to each other being produced, then advantageously it is possible to attain a particularly thin form of the optical replication component. This permits a beneficial increase in a number of holographic functions per holographic material layer. Preferably a spatial extension of HOE sub-structures of the intermittent zones of the layer of the optical replication component is substantially smaller than a diameter of the light beam, especially laser beam, of the projection unit. “Substantially smaller” in this context is to be understood as at most half as great, preferably at most one third as great, preferentially at most one fourth as great and especially preferred, at most one tenth as great. This advantageously ensures that each item of image information arrives in both exit pupils produced by the different holographic functions. It is possible for layers with different intermittent zones to be combined with full-area holographically functionalized layers.

According to an example embodiment of the present invention, it is further provided that the at least one segmentation element and the replication component be designed in such a way that the exit pupils thereby produced are disposed essentially in a raster, the distance between each two directly and/or diagonally adjacent exit pupils being less than the smallest likely pupil diameter of the user (preferably a smallest possible pupil diameter of a healthy adult man). It may thereby be ensured advantageously that at any point in time during the intended use of the virtual retinal scan display, at least one exit pupil is always visible for the user, in particular overlaps with an entrance pupil of the user eye. Advantageously, an especially large effective total eyebox may thus be obtained. In particular, various geometrical configuration patterns are possible for a configuration of the exit pupils within the eye-pupil area of the optical system (eyebox patterns). Among others, for example, an equidistant parallelogram configuration (e.g., a symmetrical or asymmetrical quincunx configuration) or a (e.g., matrix-like) quadratic configuration are possible. A “raster” is to be understood specifically as a regular pattern distributed on a surface.

In particular, the exit pupils are disposed in the eye-pupil area in such a way that (within the effective total eyebox) at least two exit pupils always enter into the user eye. An impairment and/or disturbance of the image impression by what are referred to as floaters (also called “Mouches Volantes” or “flying flies”) may thus be reduced advantageously. Floaters may be formed, inter alia, of threads or clumps of collagen fibrils which swim in a vitreous body of an eye. Particularly due to the small beam diameter of the light beams producing the imaging on the retina of the user eye in virtual retinal scan displays, floaters may almost completely block the light beam and thus throw an especially strong/sharp shadow on the retina of the user eye. If two or more light paths are present in the user eye, it is possible to ensure advantageously that a shadow impression due to a floater in one of the two light paths is reduced markedly in contrast by the other light paths.

In addition, according to an example embodiment of the present invention, it is provided that the at least one segmentation element and the optical replication component be designed in such a way that any distance between two exit pupils produced on one common imaging path is greater than the greatest likely pupil diameter of the user. In this way, an advantageous display of the image content on the retina of the user eye may be achieved, which notably is free of perceptible double images. Namely, multiple copies of an imaging of the image content which are optically identical but shifted spatially with respect to each other in the eye-pupil area are never visible simultaneously for the user. In particular, the placement of the exit pupils in the eye-pupil area is selected in such a way that the minimal distance of any exit pupil to any other exit pupil which has a twin imaging produced by replication exceeds a largest possible likely pupil diameter of a user (preferably a largest possible user-pupil diameter of a healthy adult man). Alternatively or additionally, the placement of the exit pupils in the eye-pupil area is selected in such a way that the largest possible likely user-pupil diameter is smaller than a minimum of all largest possible distances between exit pupils, switchable on and off separately or modifiable separately, from any two sets of exit pupils produced by replication and segmentation. While in the first case, all exit pupils of a set of exit pupils may be active at the same time, in the second case, only one of the exit pupils may ever be activated as a function of an instantaneous eye position, trackable particularly by an eye-tracker device.

In addition, according to an example embodiment of the present invention, it is provided that an eye-tracker device be provided for detecting and/or determining the state of the user eye, particularly for detecting and/or determining the eye movement, the speed of the eye movement, the pupil position, the pupil size, the viewing direction, the state of accommodation and/or the fixation distance of the eye. Functionality of the virtual retinal scan display may thus be improved favorably. An especially user-friendly virtual retinal scan display may be attained advantageously, which adapts the images in a manner imperceptible for the user, so that the user is able to experience the most homogeneous image impression possible. In particular, the eye-tracker device is formed as a component of the virtual retinal scan display, especially of the optical system. Detailed designs of eye trackers are described in the related art, so that they are not discussed in detail here. It is possible for the eye-tracker device to include a monocular or a binocular eye-tracking system, at least the binocular eye-tracking system being equipped especially to derive a fixation distance from counter-rotating eye movements (vergency). Alternatively or additionally, the eye-tracker device includes an eye-tracking system having a depth sensor for determining a point of vision in the surroundings in order to determine the fixation distance. Alternatively or additionally, the eye-tracker device and/or the optical system includes one or more sensors for an indirect, especially context-dependent, ascertainment of a most probable state of accommodation of the user eye, such as sensors for determining a posture of the head, GPS sensors, acceleration sensors, time-of-day chronometers and/or brightness sensors or the like. Preferably, the eye-tracker device is integrated at least partially into a component of the smart glasses, for example, into a frame of the smart glasses.

In addition, according to an example embodiment of the present invention, it is provided that individual imaging paths be controllable, and particularly that they be switchable to active and inactive, as a function of the state of the eye of the user detected especially by the eye-tracker device. Advantageously, a particularly large effective total eyebox may thus be attained, which notably at the same time has a largest possible field of vision, that moreover is beneficially free of double images. In particular, individual imaging paths are controlled as a function of the detected state of the eye of the user, preferably are switched to active or inactive, e.g., blanked, in such a way that an appearance of double images is prevented in the eye of the user, that a brightness impression on the retina of the user remains at least essentially constant and/or that the user perceives an image that for the most part is constant at all viewing angles within the total eyebox. Namely, the control- or automatic control unit and/or the image-processing device is/are provided to control, particularly to activate or deactivate, individual imaging paths as a function of the detected state of the eye of the user.

In addition, according to an example embodiment of the present invention, it is proposed that the activation and deactivation of the individual imaging paths and the design of the at least one segmentation element and the replication component be coordinated with each other in such a way that only one exit pupil is ever produced in the region of the pupil of the user per activated imaging path, the largest likely pupil diameter being taken as a basis. Advantageously, a particularly large effective total eyebox may thus be attained, which notably at the same time has a largest possible field of vision, that moreover is beneficially free of double images. In particular, imaging paths, of which at least two resulting exit pupils lie in the area of the largest likely pupil diameter, that is, specifically would enter into the user eye at one point in time, are switched off, especially blanked, at this point in time. In particular, it is necessary to avoid the situation where multiple exit pupils, set apart from each other but including identically parameterized/modified image contents, come through the pupil of the user eye at the same time (e.g., one exit pupil and one further exit pupil doubled by replication of this exit pupil), and consequently multiple image contents, not able to be parameterized/modified independently of each other, strike the retina of the user eye and thus produce image contents not lying one on top of the other.

Furthermore, according to an example embodiment of the present invention, it is proposed that the image-processing device be equipped to take into account the detected state of the eye of the user when generating the sub-image data and/or to consider which image paths are activated and which image paths are deactivated in order to compensate for variations in brightness caused as a result in the image impression. This advantageously makes it possible to produce the most constant brightness impression possible. For example, a change in the position and/or size of the pupil of the user eye alters a participation of the exit pupils which would enter into the user eye, that is, which would have a share in the superimposed imaging of the image content onto the retina of the user eye. A brightness impression may thus vary (more exit pupils enter into the user eye and superimpose to form one common imaging: brighter; fewer exit pupils enter into the user eye and superimpose to form one common imaging: darker). Specifically, in order to avoid this fluctuating brightness impression and preferably to achieve a homogeneous image brightness, individual imaging paths are switched on/switched off dynamically by the control- or automatic control unit and/or by the image-processing device. In particular, the control- or automatic control unit and/or the image-processing device is/are equipped to activate and deactivate the individual switchable imaging paths producing the exit pupils, in such a way that an at least essentially constant number of exit pupils always comes through the pupil of the user eye. Alternatively or additionally, the control- or automatic control unit and/or the image-processing device may be provided to control in open or closed loop a global brightness of all exit pupils, especially the image contents directed via the exit pupils into the user eye, according to a number of exit pupils currently coming through the pupil. In each case, a total energy demand may be reduced beneficially. In particular, the switched-on exit pupils may be selected and/or the global brightness of the exit pupils may also be adjusted by a manual indication of the viewing direction or a manual regulation of the brightness. Preferably, however, the selection is accomplished by an automated determination of the position and/or the size of the pupil of the user eye, for example, with the aid of a device for detecting eye movements, especially the eye-tracker device of the optical system.

Particularly in the case of a dynamic control of the exit pupils, especially of the included image contents directed through the exit pupils into the user eye, flickering and thus an unpleasant image impression may come about due to inaccurate and/or imprecise measurements of the pupil position and/or pupil size. In order to avoid this flickering, the control- or automatic control unit and/or the image-processing device may be equipped advantageously to provide a hysteresis and/or a delay in the control of the exit pupils. In addition, particularly in the case of delayed measurements by the eye-tracker device, an adjustment may be delayed and an image content may be degraded or lost from time to time. Advantageously, a minimum requirement of the updating rate of 200 Hz may be provided for the eye tracking as a corrective measure. In particular, it is possible for the control- or automatic control unit and/or the eye-tracker device to be equipped to precalculate target-fixation points of saccades (rapid ballistic eye movements). The minimal demand on the eye-tracker device mentioned above may thus advantageously be reduced.

Furthermore, according to an example embodiment of the present invention, it is proposed that the image-processing device be equipped to take into account and to compensate for a defective vision and/or defective accommodation of the user when generating the sub-image data, particularly by a virtual visual-acuity correction and/or by a virtual user-eye-accommodation adjustment. Functionality of the virtual retinal scan display may thus be favorably improved. Advantageously, use of the virtual retinal scan display may be made possible regardless of a visual acuity and/or regardless of further visual-acuity correction devices such as contact lenses. Particularly in the case of defective vision, parallel beams with identical imagings from the individual exit pupils are focused before (nearsightedness) or behind (farsightedness) the retina of the user eye, and may thus strike at different points on the retina, which leads to an unwanted double image. Notably, the virtual retinal scan display includes a functionality for the visual-acuity correction of the virtual image contents. Namely, for the visual-acuity correction of the virtual image contents, all exit pupils may be switched off except for one, thus advantageously ruling out double images. A small effective beam diameter at the eye and therefore great depth of focus are obtained favorably in this manner. Alternatively, for the visual-acuity correction of the virtual image contents, the parameterization, especially the image modification (image distortion, etc.) of the sub-image data, preferably of the individual sub-images, may be adapted, for example, to the specific defective vision of the user eye by the control- or automatic control unit and/or by the image-processing device. Advantageously, a virtual pair of glasses/virtual visual-acuity correction may thus be achieved. Particularly in the parameterization, especially in the image modification (e.g., image distortion, etc.), of the sub-image data and/or the sub-images, identical image contents from the individual exit pupils are divided into divergent (shortsightedness) or convergent (farsightedness) beams. Notably, the optical system includes an input function, by which a visual-acuity value of the user is able to be input. Based on the set visual-acuity value, in particular, the correction thereby necessary, especially the parameterization/modification of the sub-image data and/or the sub-images, is also taken into account by the control- or automatic control unit and/or by the image-processing device in adapting the sub-image data and/or the sub-images.

In addition, the virtual user-eye-accommodation adaptation advantageously makes it possible to use the virtual retinal scan display at least essentially regardless of an accommodation of the user eye. Particularly in the case of a near accommodation of the user eye (curvature of the eye lens: increase of the refractive power of the eye lens), parallel beams (comparable to nearsightedness) having the same image contents from the individual exit pupils are focused in front of the retina of the user eye, which likewise may lead to unwanted double images. Notably, the optical system includes a functionality for the accommodation correction of the image contents displayed. For the accommodation correction of the image contents displayed, specifically all exit pupils except one, that is, particularly all individually switchable imaging paths except one are switched off, so that double images may be ruled out advantageously. Alternatively, for the accommodation correction of the image contents displayed, the parameterization, especially the image modification (e.g., the image distortion), of the sub-image data and/or sub-images, may be adapted, for example, by the control- or automatic control unit and/or by the image-processing device to the specific accommodation of the user eye. To that end, particularly in the parameterization, especially in the image modification, of the sub-image data and/or the sub-images, identical image contents from the individual exit pupils are divided into divergent beams. In particular, the state of accommodation of the user eyes may be set manually (e.g., with the aid of a switch on the smart glasses), or may be determined in automated fashion and transmitted to the control- or automatic control unit and/or the image-processing device. For example, the state of accommodation may be set manually by switching between discrete distances (near/far), by context profiles (workplace, indoor, outdoor, means of transportation, sport, etc.) and/or by setting a continuous distance range (e.g., via a slider interaction element in an app belonging to the optical system).

In addition, according to an example embodiment of the present invention, it is proposed that the optical system include a pair of smart glasses having a frame and lenses, that the at least one projector unit and the at least one segmentation element be mounted on the frame, and that the at least one diverting unit be disposed together with the at least one replication component in the area of at least one lens, especially that it be integrated into at least one lens. An advantageous design of the smart glasses and/or an advantageous integration of the virtual retinal scan display may thus be attained. In particular, the smart glasses may also include more than one projector unit, more than one segmentation element, more than one diverting element and/or more than one replication component, in each instance one for each lens of the smart glasses, for example.

Alternatively, according to an example embodiment of the present invention, it is proposed that the image source be disposed together with the image-processing device in an external unit, and that the sub-image data be transmitted from the external unit to the projector unit of the smart glasses. An advantageous design of the smart glasses may thus be achieved which, inter alia, has an especially low weight and/or is able to be produced particularly cost-effectively. In particular, the smart glasses have a wireless or wire-bound communication device which is equipped at least to receive the sub-image data from the external unit. The external unit is formed expressly as a unit external to the smart glasses. For instance, the external unit may be in the form of a smart phone, a tablet, a personal computer (e.g., a Notebook) or the like.

Furthermore, according to an example embodiment of the present invention, a method is proposed for projecting image contents onto the retina of a user with the aid of an optical system, the optical system including at least one image source which supplies an image content in the form of image data, an image-processing device for the image data, a projector unit having a temporally modulable light source for generating at least one light beam and having a controllable deflecting device for the at least one light beam for the scanning projection of the image content, a diverting unit onto which the image content is projected and which directs the projected image content onto an eye of a user, an optical segmentation element positioned between the projector unit and diverting unit, and an optical replication component which is disposed in a projection region of the diverting unit, and the image content being projected with the aid of the optical segmentation element via different imaging paths onto at least one projection region of the diverting unit, at least individual imaging paths being controlled individually, the projected image content being replicated with the aid of the replication component and being directed, spatially offset, onto the eye of the user, so that a plurality of mutually spatially offset exit pupils is produced having the image content, sub-image data for controlling the projector unit being generated from the image data of the image source, the sub-image data permitting projection of the image content via different imaging paths onto at least one projection region of the diverting unit, and different sub-image data being generated for at least two different imaging paths, so that a distortion of the image content is compensated for at least to some extent via the respective imaging path. Functionality of the virtual retinal scan display may thus be improved beneficially. Advantageously, a particularly large effective total eyebox may be attained, which notably at the same time has a largest possible field of vision.

The optical system according to the present invention and the method according to the present invention are not intended to be limited here to the use and specific embodiment(s) described above. In particular, the optical system of the present invention and the method of the present invention may have a number of individual elements, components and units as well as method steps differing from s number indicated herein for fulfilling a mode of operation described herein. In addition, in the case of the value ranges indicated in this disclosure, values lying within the indicated limits are also to be regarded as disclosed and usable as desired.

### BRIEF DESCRIPTION OF THE DRAWINGS

Further advantages are derived from the following description of the figures. The figures show four exemplary embodiments of the present invention. The figures and the description contain numerous features in combination. One skilled in the art will expediently consider the features individually, as well, and combine them to form further useful combinations.

FIG. 1 shows a schematic representation of an optical system having a pair of smart glasses, according to an example embodiment of the present invention.

FIG. 2 shows a schematic representation of the optical system, according to an example embodiment of the present invention.

FIG. 3 shows a schematic representation of a lens of the smart glasses, having a diverting unit with optical replication component constructed in layers, according to an example embodiment of the present invention.

FIG. 4 shows a schematic illustration of the relationship of image data, sub-image data and image that is imaged on a retina, according to an example embodiment of the present invention.

FIG. 5A shows schematically a first exemplary configuration of individual exit pupils in an eye-pupil area of the optical system, according to an example embodiment of the present invention.

FIG. 5B shows schematically a second exemplary configuration of the individual exit pupils in the eye-pupil area of the optical system, according to an example embodiment of the present invention.

FIG. 5C shows schematically a third exemplary configuration of the individual exit pupils in the eye-pupil area of the optical system, according to an example embodiment of the present invention.

FIG. 6 shows a schematic representation of an effective total eyebox of the optical system, according to an example embodiment of the present invention.

FIG. 7 shows a schematic flow chart of a method for projecting image contents onto the retina of a user with the aid of the optical system, according to an example embodiment of the present invention.

FIG. 8 shows a schematic representation of a lens of the smart glasses, having a diverting unit with alternative optical replication component constructed in a single layer, according to an example embodiment of the present invention.

FIG. 9 shows a schematic representation of a further alternative optical system, according to an example embodiment of the present invention.

FIG. 10 shows a schematic representation of a second further alternative optical system, according to an example embodiment of the present invention.

### DETAILED DESCRIPTION OF EXAMPLE EMBODIMENTS

FIG. 1 shows a schematic representation of an optical system 68a having a pair of smart glasses 66a. Smart glasses 66a have lenses 70a, 72a. Lenses 70a, 72a are predominantly transparent. Smart glasses 66a have a frame 144a with earpieces 74a, 76a. Smart glasses 66a form a part of optical system 68a. In the case shown in FIG. 1, optical system 68a includes an external unit 146a. As an example, external unit 146a takes the form of a smart phone. External unit 146a is in a data-communication connection 148a with smart glasses 66a. Alternatively, smart glasses 66a may also completely form optical system 68a. Optical system 68a is provided to form a virtual retinal scan display. In the example shown in FIG. 1, smart glasses 66a have an arithmetic logic unit 78a. Arithmetic logic unit 78a is integrated into one of earpieces 74a, 76a. Alternative placements of arithmetic logic unit 78a in smart glasses 66a, e.g., in a lens edge, are likewise possible. An “arithmetic logic unit 78a” is to be understood specifically as a controller having a processor, a memory unit, and/or an operating program, control program and/or calculation program stored in the memory unit. Arithmetic logic unit 78a is provided for operating smart glasses 66a, especially individual components of smart glasses 66a.

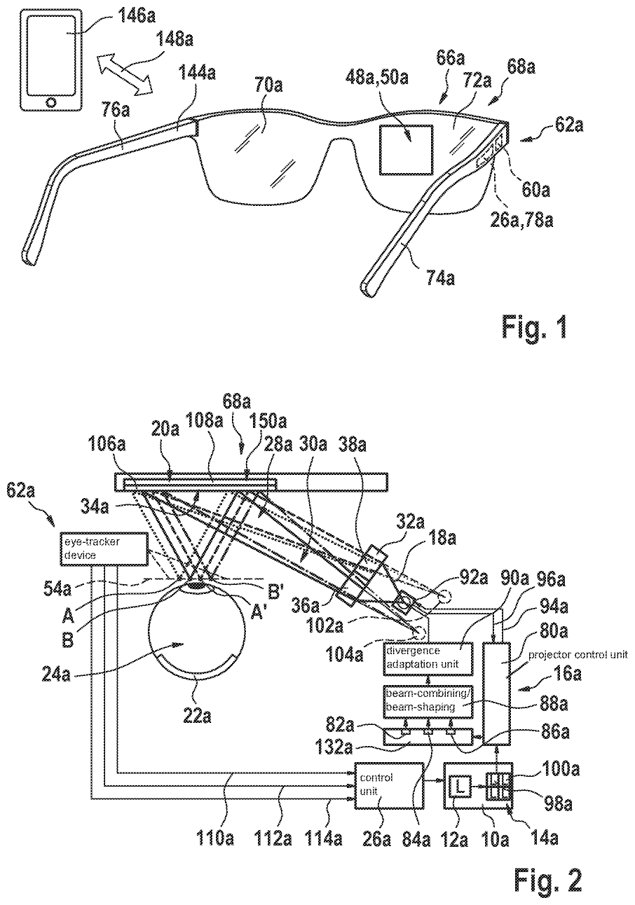

FIG. 2 shows a schematic representation of optical system 68a. Optical system 68a has an image source. The image source supplies an image content in the form of image data 12a. The image source may be an integral part of smart glasses 66a. Alternatively, the image source may also take the form of external unit 146a or part of external unit 146a. Optical system 68a has an image-processing device 10a. Image-processing device 10a is provided to digitally receive image data 12a and/or to directly generate image data 12a. Image-processing device 10a is provided for the digital processing of image data 12a. Image-processing device 10a is provided for modifying image data 12a. For example, image data 12a may form a still image or a video feed. Image-processing device 10a may be formed partially in one piece with arithmetic logic unit 78a. Image-processing device 10a is equipped to convert image data 12a into sub-image data 14a. In the exemplary embodiment shown in FIG. 2, image-processing device 10a converts image data 12a into sub-image data 14a, which include multiple sub-images 98a, 100a generated on the basis of the original image content. In this case, image-processing device 10a is equipped to generate and output the one matrix-like array of sub-images 98a, 100a within sub-image data 14a, particularly to output it to a projector unit 16a of optical system 68a.

Optical system 68a has projector unit 16a. Projector unit 16a receives sub-image data 14a from image-processing device 10a. Projector unit 16a is in the form of a laser projector unit.

Projector unit 16a is equipped to emit sub-image data 14a in the form of light beams 18a. Light beams 18a are formed as scanned laser beams. Upon each traversal of a scanning region of projector unit 16a, the scanned laser beams produce imagings of all sub-images 98a, 100a of sub-image data 14a. Projector unit 16a includes a projector control unit 80a. Projector unit 16a includes a light source 132a able to be temporally modulated. Temporally modulable light source 132a is equipped to generate light beams 18a. Projector control unit 80a is provided to control in open or closed loop the generation and/or modulation of light beams 18a by light source 132a. In the exemplary embodiment shown, light source 132a includes three (amplitude-modulable) laser diodes 82a, 84a, 86a. A first laser diode 82a produces a red laser beam. A second laser diode 84a produces a green laser beam. A third laser diode 86a produces a blue laser beam. Projector unit 16a has a beam-combining- and/or beam-shaping unit 88a. Beam-combining- and/or beam-shaping unit 88a is equipped to combine, especially to mix, the different-colored laser beams of laser diodes 82a, 84a, 86a to produce one color image. Beam-combining- and/or beam-shaping unit 88a is equipped to shape light beam 18a, especially the laser beam, which leaves projector unit 16a. Details concerning the design of beam-combining- and/or beam-shaping unit 88a are assumed as known from the related art. Projector unit 16a includes a beam-divergence adaptation unit 90a. Beam-divergence adaptation unit is provided to adapt a beam divergence of the light beam, particularly laser beam 18a, leaving projector unit 16a, preferably to adapt it to a path length of respective currently-emitted light beam 18a, the path length specifically being a function of a layout of optical elements of optical system 68a. The beam divergence of the light beams, particularly laser beams 18a leaving projector unit 16a is adapted preferably in such a way that after transiting the optical elements of optical system 68a, a sufficiently small and sharp laser spot is formed at the location at which the beam strikes a retina 22a of a user eye 24a of the virtual retinal scan display, and the beam divergence at the location of an eye-pupil area 54a of optical system 68a in front of user eye 24a is at least for the most part constant over the entire imaging produced by the light beam, particularly laser beam 18a, of image data 12a. Details concerning the design of beam-divergence adaptation unit 90a, e.g., with the aid of lenses having fixed and/or variable focal length, are assumed as known from the related art. Projector unit 16a includes at least one controllable deflecting device 92a. Controllable deflecting device 92a takes the form of a MEMS mirror. The MEMS mirror is part of a micro-mirror actuator (not shown). Controllable deflecting device 92a is equipped for a controlled deflection of the laser beam producing a raster image. Details concerning the design of the micro-mirror actuator are assumed as known from the related art. Projector-control unit 80a is equipped for an open-loop or closed-loop control of a movement of controllable deflecting device 92a (see arrow 94a). Controllable deflecting device 92a sends its instantaneous position signals back to projector-control unit 80a at regular intervals (see arrow 96a).

Optical system 68a has a diverting unit 20a. The image content is projectable onto diverting unit 20a. Diverting unit 20a is equipped to direct the projected image content onto user eye 24a. Diverting unit 20a forms a projection region 34a. Light beams 18a, which strike diverting unit 20a within projection region 34a, are diverted/projected at least partially in the direction of user eye 24a. Diverting unit 20a is equipped to influence (refract, scatter and/or reflect) light beams 18a in such a way that at least a portion of light beams 18a, preferably at least one sub-image 98a, 100a produced from image data 12a, is imaged onto eye-pupil area 54a of optical system 68a, particularly onto retina 22a of user eye 24a. Optical system 68a is equipped, with the aid of various optical elements, to form a plurality of exit pupils A, A′, B, B′. Optical system 68a is equipped, with the aid of the various optical elements, to influence light beams 18a in such a way that the exit pupils (eyeboxes) A, A′, B, B′ produced are set apart from one another. Optical system 68a forms eye-pupil area 54a. Exit pupils A, A′, B, B′ all lie side-by-side and/or one above the other in eye-pupil area 54a. Eye-pupil area 54a is formed as an area in space provided for the placement of user eye 24a (within smart glasses 66a), particularly for the placement of entrance pupils of user eye 24a (within smart glasses 66a). Eye-pupil area 54a is preferably planar, but deviates from a perfect plane due to small curvatures. Eye-pupil area 54a may be regarded/referred to approximately as an eye-pupil plane. Eye-pupil area 54a lies in a viewing direction of the user in front of lenses 70a, 72a of smart glasses 66a and runs at least essentially parallel to a lens plane of lenses 70a, 72a. The designation “essentially parallel” in this case should be understood particularly to the effect that deviations of up to 20° from a perfect plane are also included in it (keyword: facial warp and pantoscopic tilt of lenses 70a, 72a).

Optical system 68a shown by way of example in FIG. 2 is equipped to produce a spatial image segmentation of sub-image data 14a. In the spatial image segmentation, sub-image data 14a are split into (possibly modified) imagings of the image content/image data 12a, in each case separated spatially from each other. In this context, each segment then includes exactly one (complete but possibly modified) imaging of the image content/image data 12a. Optical system 68a includes at least one optical segmentation element 32a to produce the spatial segmentation of sub-image data 14a. Optical segmentation element 32a is positioned between projector unit 16a, particularly deflecting device 92a of projector unit 16a, and diverting unit 20a. With the aid of optical segmentation element 32a, the image content is projectable via different imaging paths 28a, 30a onto the at least one projection region 34a of diverting unit 20a. In the exemplary embodiment of FIG. 2, optical segmentation element 32a takes the form of a segmented lens, particularly a segmenting lens. Alternatively, optical segmentation element 32a may also be in the form of a segmenting mirror (not shown), a segmenting optical diffraction grating (not shown), a volume hologram (not shown) or a beam splitter (not shown). Optical segmentation element 32a includes several individual segments 36a, 38a, particularly individual lenses. In each case one of sub-images 98a, 100a (each representing identical copies or altered/distorted versions of the image content/image data 12a) is projected through each of individual segments 36a, 38a. In this way, for each sub-image 98a, 100a, a separate virtual deflecting device (virtual MEMS mirror) 102a, 104a is obtained disposed separately from further virtual deflecting devices (virtual MEMS mirrors) 102a, 104a and from real deflecting device 92a. In particular, virtual deflecting devices (virtual MEMS mirrors) 102a, 104a may be formed (theoretically) as point sources. In general, however, virtual deflecting devices (virtual MEMS mirrors) 102a, 104a do not form point sources, but rather astigmatic sources. Each sub-image 98a, 100a is thus radiated via a different imaging path 28a, 30a, particularly from a different angle and from a different distance, onto projection region 34a of diverting unit 20a.

Optical system 68a shown by way of example in FIG. 2 is equipped to generate image replication purely by way of optical elements of optical system 68a. Optical system 68a has an optical replication component 150a. Optical replication component 150a is disposed in projection region 34a of diverting unit 20a. Optical replication component 150a is equipped to direct the projected image content, replicated and spatially offset, to user eye 24a, so that a plurality of mutually spatially offset exit pupils A, A′, B, B′ having the image content is produced. To generate the image replication, optical replication component 150a is at least partially reflecting and at least partially transparent. Optical replication component 150a includes partially reflecting and partially transparent layers 106a, 108a. Layers 106a, 108a of optical replication component 150a have different optical functions, especially different deflection angles. Layers 106a, 108a of optical replication component 150a take the form of deflecting and/or focusing holographic optical elements (HOEs). A totality of exit pupils A, A′, B, B′ is produced by combinations of the image segmentation by way of optical segmentation element 32a and the image replication of optical replication component 150a. Optical replication component 150a is integrated into one of lenses 72a of smart glasses 66a. Optical replication component 150a is positioned in a field of vision of smart glasses 66a.

In the exemplary embodiment shown in FIG. 2, optical replication component 150a is realized in a layer structure having two holographically functionalized layers 106a, 108a. Optical replication component 150a includes two holographically functionalized layers 106a, 108a that completely overlap laterally and are disposed one after another layer-wise. In this context, layers 106a, 108 are formed in flat and uninterrupted fashion (see also FIG. 3). Optical replication component 150a is realized in a layer structure with the at least two layers 106a, 108a disposed one on top of the other and having different holographic functions, thereby producing the plurality of mutually spatially offset exit pupils A, A′, B, B′. In this context, a portion of each light beam 18a is deflected at first layer 106a, while the remainder of light beam 18a transits first layer 106a. A further part of the portion of light beam 18a transiting first layer 106a is deflected at second layer 108a, while the remainder of light beam 18a passes through second layer 108a and lens 72a into which optical replication component 150a is integrated.

The individual imaging paths 28a, 30a are controllable individually. Image-processing device 10a is equipped to generate sub-image data 14a for controlling projector unit 16a from image data 12a of the image source. Sub-image data 14a permit the image content to be projected via the at least two different imaging paths 28a, 30a of individually controllable imaging paths 28a, 30a onto projection region 34a of diverting unit 20a. Image-processing device 10a is equipped to generate different sub-image data 14a, preferably different sub-images 98a, 100a, for the at least two different imaging paths 28a, so that a distortion (produced by optical elements of optical system 68a) of the image content is compensated for at least to some extent via respective imaging path 28a, 30a. Image-processing device 10a is equipped to generate sub-image data 14a which include sub-images 98a, 100a that are modified, particularly distorted, offset, rotated or otherwise scaled relative to image data 12a. Image-processing device 10a is equipped to generate sub-image data 14a from image data 12a of the image source, sub-image data 14a permitting a simultaneous projection of N×M sub-images 98a, 100a having essentially the same image content. Optical segmentation element 32a is provided to spatially segment sub-image data 14a, so that the essentially identical image content of the N×M sub-images 98a, 100a is projected via at least two different imaging paths 28a, 30a of individually controllable imaging paths 28a, 30a onto projection region 34a of diverting unit 20a. Image-processing device 10a is equipped to switch individual imaging paths 28a, 30a to active, by making sub-image data 14a for corresponding sub-image 98a, 100a available for controlling projector unit 16a. Image-processing device 10a is equipped to switch off individual imaging paths 28a, 30a, by blanking sub-image data 14a for corresponding sub-images 98a, 100a.

Optical system 68a has an eye-tracker device 62a. Eye-tracker device 62a is integrated into one of earpieces 74a, 76a (see FIG. 1). Alternative placements of eye-tracker device 62a are possible. Eye-tracker device 62a is equipped to detect and/or determine a state of the eye of the user. Eye-tracker device 62a is equipped to detect and/or determine an eye movement of the user. Eye-tracker device 62a is equipped to detect and/or determine a speed of an eye movement of the user. Eye-tracker device 62a is equipped to detect and/or determine a pupil position of the user. Eye-tracker device 62a is equipped to detect and/or determine a pupil size of the user. Eye-tracker device 62a is equipped to detect and/or determine a viewing direction of the user. Eye-tracker device 62a is equipped to detect and/or determine a state of accommodation of the user. Eye-tracker device 62a is equipped to detect and/or determine a fixation distance of the user. At the same time, it is possible, of course, for eye-tracker device 62a to track and/or monitor only a portion of the aforementioned parameters and/or for the eye-tracker device to track and/or record even more parameters of the user or of the user surroundings. To detect the state of accommodation of user eyes 24a, in particular, a dedicated sensor hardware of eye-tracker device 62a may be provided, or a context-dependent estimation may be carried out, taking into account sensor data remote from the eye such as posture of the head, rate of rotation, acceleration, GPS data or even the image content currently displayed.

The state of activity of individual imaging paths 28a, 30a is controllable as a function of the state of the user eye detected by eye-tracker device 62a. The individual imaging paths 28a, 30a are activatable and de-activatable on the basis of the instantaneously ascertained state of user eye 24a.

Image-processing device 10a is equipped to take into account the state of the user eye, detected by eye-tracker device 62a, when generating sub-image data 14b, in order to compensate for variations in brightness thus caused in the image impression. For that, image-processing device 10a is equipped, when generating sub-image data 14a, to consider which imaging paths 28a, 30a are switched to active and which imaging paths 28a, 30a are switched off, in order to compensate for variations in brightness thus caused in the image impression. Image-processing device 10a is equipped to dynamically modify a global brightness of all sub-images 98a, 100a entering into user eye 24a at a point in time, in such a way that no variations in brightness are perceived by the user when the user changes his/her pupil position and/or viewing direction, for example.

Optical system 68a has electronic control- or automatic control unit 26a. Control- or automatic control unit 26a may be formed partially in one piece with arithmetic logic unit 78a. Control- or automatic control unit 26a shown by way of example in FIG. 2 is provided for controlling image-processing device 10a. Control- or automatic control unit 26a is equipped to control image-processing device 10a based on measurement data of eye-tracker device 62a. Control- or automatic control unit 26a receives measurement data concerning a pupil position from eye-tracker device 62a (see arrow 110a). Control- or automatic control unit 26a receives measurement data concerning a pupil size from eye-tracker device 62a (see arrow 112a). Control- or automatic control unit 26a receives measurement data concerning the viewing direction of the user from eye-tracker device 62a (see arrow 114a). Control- or automatic control unit 26a generates open-loop or closed-loop control commands for controlling image-processing device 10a based on the data of eye-tracker device 62a. For example, these commands may be provided to activate, deactivate or adapt (parameterize/distort/scale) individual sub-images 98a, 100a of sub-image data 14a. Control- or automatic control unit 26a is equipped, depending on at least one measured value of eye-tracker device 62a, to parameterize, preferably to modify sub-image data 14a, output by image-processing device 10a, in such a way that in the event of a simultaneous entry into user eye 24a, the different imagings of the image content of image data 12a contained in a portion of the various exit pupils A, B are superimposed as exactly as possible on retina 22a of user eye 24a (see FIG. 4).

In this context, the parameterization/modification of the different imagings of the image content of image data 12a which are contained in these exit pupils A, B includes a virtual visual-acuity correction. Image-processing device 10a is equipped to compensate for a defective vision of the user when generating sub-image data 14a, particularly by the parameterization/modification of the original image data 12a. Because exit pupils A′, B′ multiplied in the replication are copies of exit pupils A, B, which also would have been produced without replication, these copies likewise include the virtual visual-acuity correction. In addition, the parameterization/modification of the different imagings of the image content of image data 12a which are contained in these exit pupils A, B includes a virtual user-eye-accommodation adaptation. Image-processing device 10a is equipped to compensate for a defective accommodation of the user when generating sub-image data 14a, particularly by the parameterization/modification of original image data 12a. Because exit pupils A′, B′ multiplied in the replication are copies of exit pupils A, B, which also would have been produced without replication, these copies likewise include the virtual user-eye-accommodation adaptation.

While in the representation of FIG. 1, projector unit 16a and optical segmentation element 32a are mounted by way of example on frame 144a, and diverting unit 20a is positioned with replication component 150a in the area of a lens 72a, in particular is integrated into at least lens 72a, alternatively it is also possible that at least the image source is disposed together with image-processing device 10a in external unit 146a, and that sub-image data 14a are transmitted from external unit 146a to projector unit 16a of smart glasses 66a.

FIG. 4 shows a schematic illustration of the relationship of image data 12a (left column), (parameterized/modified) sub-image data 14a (middle column) and image imaged on retina 22a (right column). The left column shows image data 12a generated by image-processing device 10a/received by image-processing device The middle column shows sub-image data 14a parameterized/modified by image-processing device 10a and divided in matrix form. The middle column shows sub-image data 14a output by projector unit 16a. Sub-image data 14a include (partially parameterized/modified/scaled) sub-images 98a, 100a. The right column shows possible imagings on retina 22a of user eye 24a. In the case of identical (unparameterized/unmodified/undistorted) sub-images 98a, 100a (first row), superimposition of the image contents which come from exit pupils A, A′, B, B′ entering into user eye 24a may be insufficient. By shifting, rotating, rescaling and/or distorting sub-images 98a 100a, particularly in the projector image, the same visual impression is always produced on retina 22a, even if several individual exit pupils A, A′, B, B′ are located exactly in the area of the pupil of user eye 24a. If several exit pupils A, A′, B, B′ are located simultaneously in the area of the pupil of user eye 24a, given suitable parameterization, sub-images 98a, 100a of sub-image data 14a superimpose so well that no double image develops (second row). In the case of a defective accommodation of user eye 24a, particularly in the case of an accommodation of user eye 24a unsuitable for the current setting of optical system 68a, due to the altered refractive power of user eye 24a, each of sub-images 98a, 100a would be imaged with a slight shift on retina 22a, which again leads to a double image (third row). The same effect may occur in the case of a defective vision of user eye 24a. Starting from the case shown in the third row, this may be offset by a modification of sub-images 98a, 100a (like second row with different parameterization). Alternatively, the formation of double images in response to a defective accommodation or a defective vision may also be avoided by activation of only one exit pupil A, A′, B, B′ entering into user eye 24a, that is, of only one sub-image 98a (fourth row).

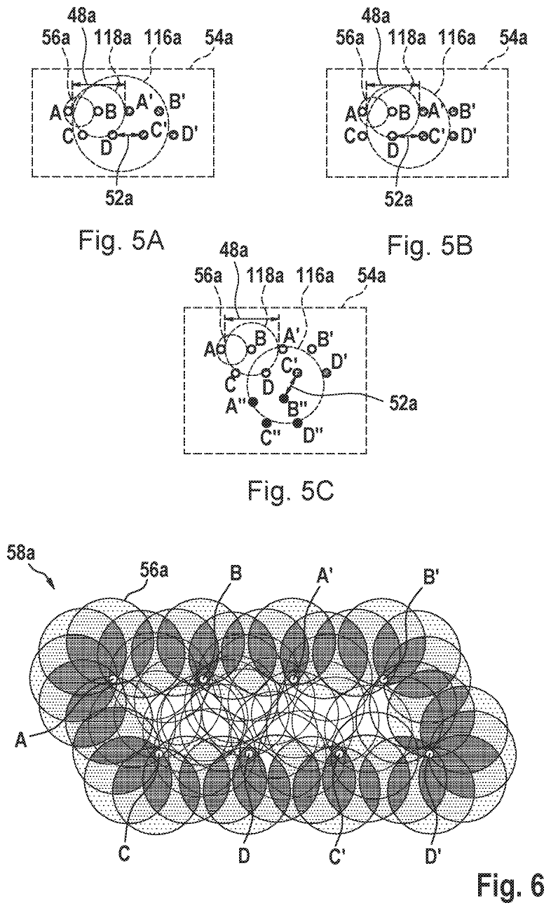

FIG. 5A shows schematically a first exemplary configuration of individual exit pupils A, A′, B, B′, C, C′, D, D′ in eye-pupil area 54a in a parallelogram configuration with a single replication. Optical segmentation element 32a and optical replication component 150a are designed in such a way that exit pupils A, A′, B, B′, C, C′, D, D′ thereby produced are disposed essentially in a raster. In the case shown by way of example in FIG. 5A, due to the segmentation with the aid of a segment lens having 2×2 segments and due to a deflection at a first HOE function (first layer 106a of optical replication component 150a), a first set of exit pupils is obtained having four individual exit pupils A, B, C, D. These four exit pupils A, B, C, D are each switchable separately from each other. These four exit pupils A, B, C, D are each produced via imaging paths that differ from each other. Due to the replication with the aid of the second HOE function (second layer 108a of optical replication component 150a), a further set of exit pupils is obtained, likewise having four individual exit pupils A′, B′, C′, D′. These four exit pupils A′, B′, C′, D′ are copies of exit pupils A, B, C, D switchable independently of each other, and therefore are only switchable dependent on exit pupils A, B, C, D, that is, exit pupils A′, B′, C′, D′ always have the same state of activity as exit pupils A, B, C, D and contain the same (parameterized/modified) sub-images 98a, 100a. A largest possible minimal distance 52a between two adjacent exit pupils A, B, C, D in eye-pupil area 54a is smaller than a smallest likely user-pupil diameter 56a. A configuration of exit pupils A, A′, B, B′, C, C′, D, D′ in eye-pupil area 54a and/or a switchability of exit pupils A, B, C, D is/are selected in such a way as to ensure that at no point in time do two exit pupils A, A′, B, B′, C, C′, D, D′, which are produced on one common imaging path 28a, 30a, reach retina 22a of user eye 24a simultaneously. In the example shown in FIG. 5A, in each case the pairs with the same letters include identical imagings of the image content. Identical letters in the figures designate exit pupils A, A′, B, B′, C, C′, D, D′ having a common imaging path 28a, 30a. In the example shown in FIG. 5A, a largest possible pupil diameter 116a, identified by a circle, contains two or more exit pupils A, A′, B, B′, C, C′, D, D′ that include identical imagings of the image content. Therefore, in the exit-pupil configuration shown, all except for one of exit pupils A, A′, B, B′, C, C′, D, D′ must be deactivated in order to avoid double images. For instance, in the case shown in FIG. 5A, only exit pupil A or only exit pupil D may be activated. In this case, the activation and deactivation of individual imaging paths 28a, 30a and the design of optical segmentation element 32a and of optical replication component 150a are matched to each other in such a way that per imaging path 28a, 30a switched to active, only a single exit pupil of exit pupils A, A′, B, B′, C, C′, D, D′ is ever produced in the area of the pupil of the user. A further circle represents a largest possible pupil diameter 118a for which all exit pupils may still be activated without the development of double images. Optical segmentation element 32a and optical replication component 150a are designed in such a way that any distance 48a between two exit pupils A and A′ or B and B′, etc. produced on one common imaging path 28a, 30a is greater than the greatest likely pupil diameter 116a, 118a of the user.

FIG. 5B shows schematically a second exemplary configuration of individual exit pupils A, A′, B, B′, C, C′, D, D′ in eye-pupil area 54a in a square configuration with a single replication. Pupil diameters 56a, 116a, 118a described above are also shown in FIG. 5B.

FIG. 5C shows schematically a third exemplary configuration of individual exit pupils A, A′, A″, B, B′, B″, C, C′, C″, D, D′, D″ in eye-pupil area 54a in a quincunx configuration with a double replication. Pupil diameters 56a, 116a, 118a described above are also shown in FIG. 5C.

FIG. 6 shows schematically an effective total eyebox 58a of the optical system. Effective total eyebox 58a is obtained by coverage of an area made up of a raster of individual exit pupils A, A′, B, B′, C, C′, D, D′ at sufficiently small distance relative to each other, so that even in the case of minimal pupil diameter 56a, it is ensured that light is able to be transmitted from at least one exit pupil A, A′, B, B′, C, C′, D, D′ through the pupil of user eye 24a.

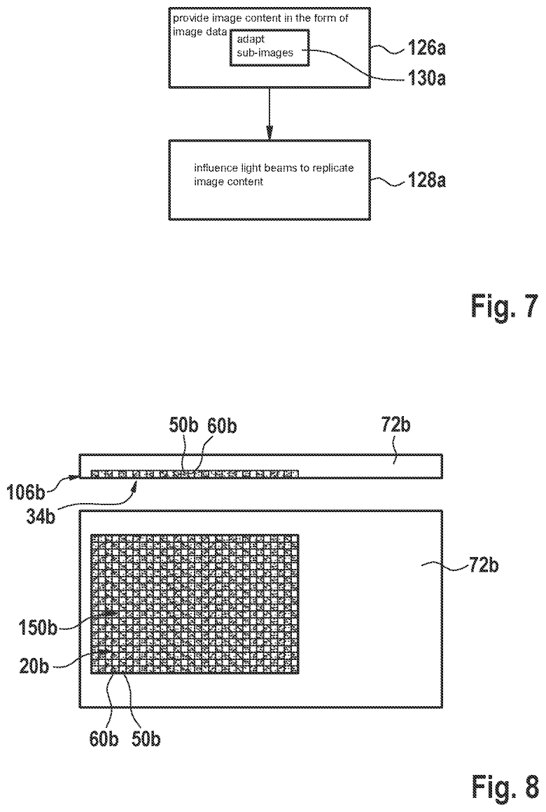

FIG. 7 shows a schematic flow chart of a method for projecting image contents onto retina 22a of a user, preferably for displaying a raster image directly on retina 22a of user eye 24a, with the aid of optical system 68a. In at least one method step 126a, an image source provides an image content in the form of image data 12a. In method step 126a, image data 12a including the image content are generated and emitted (possibly modified) in the form of scanned light beams 18a, in order to image a scanning projection of the image content on retina 22a of user eye 24a. In at least one further method step 128a, with the aid of optical segmentation element 32a, light beams 18a are influenced in such a way that the image content is projected via different imaging paths 28a, 30a onto projection region 34a of diverting unit 20a, the different imaging paths 28a, 30a being controlled individually. In addition, in method step 128a, light beams 18a are influenced with the aid of optical replication component 150a in such a way that the projected image content is replicated and directed, spatially offset, onto user eye 24a. In this way, in method step 128a, a plurality of mutually spatially offset exit pupils A, A′, B, B′ having the image content is produced. In at least one further method step 130a, forming a sub-step of image-data-generating method step 126a, in order to avoid double images, sub-images 98a, 100a contained in exit pupils A, A′, B, B′ are adapted, especially activated, deactivated and/or distorted/shifted/scaled, in such a way that either multiple exit pupils A, A′, B, B′ are prevented from entering into user eye 24a simultaneously, or the imagings of multiple exit pupils A, A′, B, B′ entered into user eye 24a are almost exactly superimposed. In method step 130a, sub-images 98a, 100a are adapted as a function of measurement data of eye-tracker device 62a. In method step 130a, sub-image data 14a for controlling projector unit 16a are produced from image data 12a of the image source, sub-image data 14a permitting projection of the image content via the different imaging paths 28a, 30a onto projection region 34a of diverting unit 20a, and different sub-image data 14a, particularly different sub-images 98a, 100a being produced for at least two different imaging paths 28a, so that a distortion of the image content produced, e.g., by optical elements of optical system 68a, is compensated for at least to some extent via respective imaging path 28a, 30a. Various methods for suitable controls of components of optical system 68a are described herein by way of example.

FIGS. 8 through 10 show three further exemplary embodiments of the present invention. The following descriptions and the figures are limited essentially to the differences between the exemplary embodiments; in general, one may also refer to the figures and/or the description of the other exemplary embodiments, particularly of FIGS. 1 through 7, with respect to identically denoted components, especially with regard to components having the same reference numerals. To differentiate the exemplary embodiments, the letter a is placed after the reference numerals of the exemplary embodiment in FIGS. 1 through 7. In the exemplary embodiments of FIGS. 8 through 10, the letter a is replaced by the letters b through d.

FIG. 8 shows schematically a top view and a rear view of a lens 72b of a pair of smart glasses 66b of an alternative optical system 68b, which has an alternative diverting unit 20b with an alternative optical replication component 150b. Optical replication component 150b includes one layer 106b in which two different holographic functions are realized. The different holographic functions are formed in one common plane but in different intermittent zones 50b, 60b of layer 106b. In this way, a plurality of mutually spatially offset exit pupils A, A′, B, B′ is produced, as well.

Intermittent zones 50b, 60b having the different holographic functions in each case form a HOE. Zones 50b, 60b having the different holographic functions are spatially interlaced in one common plane. Zones 50b, 60b having the different holographic functions are disposed in a checker-board-like pattern in the common plane.

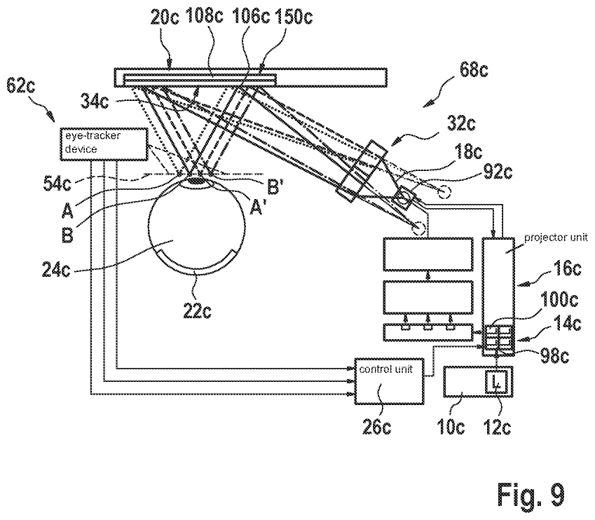

FIG. 9 shows a schematic representation of a further alternative optical system 68c. Optical system 68c has an image-processing device 10c. Image-processing device 10c is provided to digitally receive image data 12c and/or to directly generate image data 12c. Optical system 68c has a projector unit 16c. Image-processing device 10c is provided to output image data 12c to projector unit 16c. Projector unit 16c is provided to generate sub-image data 14c from received image data 12c. In the exemplary embodiment shown in FIG. 9, projector unit 16c is equipped, when generating sub-image data 14c, to split image data 12c into multiple sub-images 98c, 100c including (possibly modified) copies of the image content. Projector unit 16c is equipped to emit sub-image data 14c, particularly sub-images 98c, 100c in the form of scanned laser beams. Optical system 68c has an alternative electronic control- or automatic control unit 26c. Control- or automatic control unit 26c shown by way of example in FIG. 9 is provided at least for controlling projector unit 16c. Control- or automatic control unit 26c is equipped to control projector unit 16c based on measurement data of an eye-tracker device 62c of optical system 68c. Control- or automatic control unit 26c generates open-loop or closed-loop control commands for controlling projector unit 16c based on the data of eye-tracker device 62c. For example, these commands may be provided to activate, deactivate or adapt (parameterize/distort) sub-image data 14c, particularly individual sub-images 98c, 100c in sub-image data 14c.

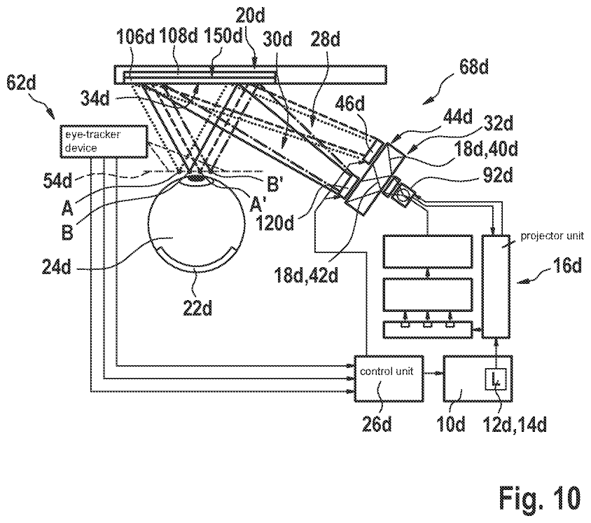

FIG. 10 shows a schematic representation of a second further alternative optical system 68d. Optical system 68d has an image-processing device 10d. Image-processing device 10d is provided to digitally receive image data 12d and/or to directly generate image data 12d. Image-processing device 10d is provided for the digital processing of image data 12d. In this context, image-processing device 10d generates sub-image data 14d. Optical system 68d has a projector unit 16d. Image-processing device 10d is provided to output sub-image data 14d to projector unit 16d. Projector unit 16d is equipped to emit sub-image data 14d in the form of light beams 18d, especially in the form of scanned laser beams. Optical system 68d has an alternative optical segmentation element 32d. Optical segmentation element 32d is positioned between projector unit 16d and a diverting unit 20d of optical system 68d. Optical segmentation element 32d is equipped to produce a temporal image segmentation of image data 12d. Optical segmentation element 32d is in the form of a beam-splitter assembly 44d. Beam-splitter assembly 44d is provided to split light beams 18d, particularly the scanned laser beams, into partial beams 40d, 42d. Beam-splitter assembly 44d is provided to produce the temporal segmentation. Optical segmentation element 32d has beam-splitter assembly 44d to produce the temporal segmentation. Beam-splitter assembly 44d is provided to multiply the projected image content N×M-fold, so that the image content is projectable on N×M different imaging paths 28d, 30d onto at least one projection region 34d of diverting unit 20d.

In addition, beam-splitter assembly 44d has optical switch elements 46d, 120d. Optical switch elements 46d, 120d, in combination with beam-splitter assembly 44d, are provided to perform the temporal segmentation. At least one portion of imaging paths 28d, 30d is able to be either activated or deactivated via each of optical switch elements 46d, 120d. Exactly one optical switch element 46d, 120d is assigned to, particularly is downstream of, each partial beam 40d, 42d, which was produced by beam-splitter assembly 44d. Each partial beam 42d produces a different imaging path 28d, 30d. Optical system 68d has a further alternative electronic control- or automatic control unit 26d. Control- or automatic control unit 26d is provided to control image-processing device 10d. Control- or automatic control unit 26d is equipped to control image-processing device 10d based on measurement data of an eye-tracker device 62d of optical system 68d. Control- or automatic control unit 26d generates open-loop or closed-loop control commands for controlling image-processing device 10d based on the data of eye-tracker device 62d. For example, these commands may be provided to adapt (parameterize/distort/scale/shift) sub-image data 14d, especially sub-images 98d, 100d of sub-image data 14d, particularly in phase with switching cycles of optical switch elements 46d, 120d. Sub-image data 14d are generated/modified by image-processing device 10d as a function of the imaging path 28d, 30d presently open in each case. Control- or automatic control unit 26d is equipped to parameterize, preferably to modify, sub-image data 14d, especially sub-images 98d, 100d of sub-image data 14d, output by image-processing device 10d, as a function of at least one measured value of eye-tracker device 62d in such a way that, in the event of a simultaneous entry into a user eye 24d, the different imagings of the image content imaged via different imaging paths 28d, 30d are superimposed as exactly as possible on a retina 22d of user eye 24d. Image-processing device 10d is equipped to generate sub-image data 14d for controlling projector unit 16d from image data 12d of the image source, so that a distortion of the image content, produced, e.g., by optical elements of optical system 68d, is compensated for via imaging path(s) 28d, 30d switched to active in each instance. Notably, no spatially divided sub-image generation takes place in the exemplary embodiment shown in FIG. 10, however could, of course, be combined with the temporally divided sub-image generation.

Control- or automatic control unit 26d shown by way of example in FIG. 10 is equipped to control optical switch elements 46d, 120d. Control- or automatic control unit 26d generates open-loop or closed-loop control commands for controlling optical switch elements 46d, 120d based on the data of eye-tracker device 62d. For instance, these commands may be provided to activate or deactivate individual exit pupils A, A′, B, B′ controlled by optical switch elements 46d, 120d. Control- or automatic control unit 26d is equipped to control optical switch elements 46d, 120d as a function of at least one measured value of eye-tracker device 62d, in such a way that individual imagings of the image content (different exit pupils A, A′, B, B′) produced via different imaging paths 28d, 30d may be deactivated in the event of a simultaneous entry into user eye 24d.

Optical switch element 46d, 120d may be realized as a component of beam-splitter assembly 44d, or (as indicated in FIG. 10) as a separate filter element able to be positioned in the output-beam path of beam-splitter assembly 44d. In the exemplary embodiment shown, optical switch element 46d, 120d is realized in the form of an optical shutter. Alternatively, however, a form of optical switch element 46d, 120d as an electro-optical modulator, as an acousto-optical modulator, as a photo-elastic modulator, as an electrically controllable polarization filter and/or as an electrically controllable liquid lens is also possible.

1-23. (canceled)

24. An optical system for a virtual retinal scan display, comprising:
an image source which provides an image content in the form of image data;
an image-processing device for the image data;
a projector unit having a light source, able to be temporally modulated, configured to generate at least one light beam, and having a controllable deflecting device for the at least one light beam for a scanning projection of the image content;
a diverting unit onto which the image content is able to be projected, and which is equipped to direct the projected image content onto an eye of a user;
an optical segmentation element, positioned between the projector unit and the diverting unit, using which the image content is projectable via different imaging paths onto at least one projection region of the diverting unit, at least individual ones of the imaging paths being controllable individually; and
an optical replication component disposed in the at least one projection region of the diverting unit and equipped to direct the projected image content, replicated and spatially offset, onto the eye of the user, so that a plurality of mutually spatially offset exit pupils having the image content is produced.

25. The optical system as recited in claim 24, wherein the image-processing device is equipped to generate sub-image data from the image data of the image source to control the projector unit, the sub-image data permitting projection of the image content via at least two different imaging paths of the individually controllable imaging paths onto at least one projection region of the diverting unit, and the image-processing device is equipped to generate different sub-image data for the at least two different imaging paths, so that a distortion of the image content is compensated for at least to some extent via the respective imaging path.

26. The optical system as recited in 24, wherein the image-processing device is equipped to generate sub-image data from the image data of the image source, the sub-image data permitting a simultaneous projection of N×M sub-images having essentially identical image content, and the optical segmentation element performs a spatial segmentation, so that the essentially identical image content of the N×M sub-images is projected via at least two different imaging paths of the individually controllable imaging paths onto the at least one projection region of the diverting unit.

27. The optical system as recited in claim 26, wherein the image-processing device is equipped to switch individual imaging paths to active by making the sub-image data for a corresponding sub-image available for controlling the projector unit, and to deactivate individual imaging paths by blanking the sub-image data for the corresponding sub-images.

28. The optical system as recited in claim 24, wherein the optical segmentation element is a segmenting lens, or a segmenting mirror, or a segmenting optical diffraction grating, or volume hologram, or a beam splitter.

29. The optical system as recited in claim 24, wherein the optical segmentation element is a beam-splitter assembly that multiplies the projected image content N×M-fold, so that the image content is able to be projected on N×M different imaging paths onto at least one projection region of the diverting unit, the beam-splitter assembly is assigned at least one optical switch element with which at least a portion of the imaging paths is switchable either to active or inactive, and the image-processing device is equipped to generate sub-image data for controlling the projector unit from the image data of the image source, so that a distortion of the image content is compensated for at least to some extent via the at least one imaging path switched to active.

30. The optical system as recited in claim 29, wherein the optical switch element is a component of the beam-splitter assembly or a separate filter element able to be positioned in an output-beam path of the beam-splitter assembly.

31. The optical system as recited in claim 29, wherein the optical switch element is an electrically controllable polarization filter and/or an electro-optical modulator and/or an acousto-optical modulator and/or a photo-elastic modulator and/or an optical shutter and/or an electrically controllable liquid lens.

32. The optical system as recited in claim 24, wherein the optical replication component is a layer structure having at least one holographically functionalized layer.

33. The optical system as recited in claim 24, wherein the optical replication component is a layer structure having at least two layers, disposed one above the other, having different holographic functions, whereby the plurality of mutually spatially offset exit pupils is produced.

34. The optical system as recited in claim 32, wherein the optical replication component includes at least one layer in which at least two different holographic functions are realized, and the different holographic functions are formed in one common plane but in different intermittent zones of the layer, using which the plurality of mutually spatially offset exit pupils is produced.

35. The optical system as recited in claim 24, wherein the at least one optical segmentation element and the optical replication component are configured in such a way that the exit pupils thus produced are disposed in a raster, a distance between each two directly and/or diagonally adjacent exit pupils being less than a smallest likely pupil diameter of the user.

36. The optical system as recited in claim 24, wherein the at least one optical segmentation element and the optical replication component are configured in such a way that any distance between two exit pupils produced on one common imaging path is greater than a greatest likely pupil diameter of the user.

37. The optical system as recited in claim 24, further comprising:
an eye-tracker device configured to detect and/or determine a state of the eye of the user, the state of the eye including: an eye movement, and/or a speed of the eye movement, and/or a pupil position, and/or a pupil size, and/or a viewing direction, and/or a state of accommodation, and/or a fixation distance of the eye.

38. The optical system as recited in claim 37, wherein individual imaging paths are controllable and are able to be activated and deactivated as a function of the detected state of the eye of the user.

39. The optical system as recited in claim 38, wherein the activation and deactivation of the individual imaging paths and a configuration of the at least one optical segmentation element and the optical replication component are matched to each other in such a way that only one exit pupil is ever produced in a region of the pupil of the user per activated imaging path, a largest likely pupil diameter being taken as a basis.

40. The optical system as recited in claim 38, wherein the image-processing device is equipped to take into account the detected state of the eye of the user when generating sub-image data and/or to consider which imaging paths are activated and which imaging paths are deactivated in order to compensate for variations in brightness caused as a result in an image impression.

41. The optical system as recited in claim 25, wherein the image-processing device is equipped to take into account and to compensate for a defective vision and/or defective accommodation of the user when generating the sub-image data.

42. The optical system as recited in claim 25, further comprising:
a pair of smart glasses having a frame and lenses, wherein the at least one projector unit and the at least one optical segmentation element are mounted on the frame, and the at least one diverting unit together with the at least one optical replication component is integrated in at least one lens.

43. The optical system as recited in claim 42, wherein the image source is disposed together with the image-processing device in an external unit, and the sub-image data are transmitted from the external unit to the projector unit of the smart glasses.

44. The optical system as recited in claim 42, wherein the image source is disposed in an external unit, the image-processing device is mounted together with the projector unit on the frame, and the image data are transmitted from the external unit to the image-processing device of the smart glasses.

45. A method for projecting image contents onto a retina of a user using an optical system which includes:
an image source which provides an image content in the form of image data,
an image-processing device for the image data,
a projector unit having a light source, able to be modulated temporally, configured to generate at least one light beam, and having a controllable deflecting device for the at least one light beam for a scanning projection of the image content,
a diverting unit onto which the image content is projected, and which directs the projected image content onto an eye of a user,
an optical segmentation element positioned between the projector unit and the diverting unit, and
an optical replication component disposed in a projection region of the diverting unit,
the method comprising the following steps:
projecting the image content using the optical segmentation element via different imaging paths onto at least one projection region of the diverting unit, at least individual imaging paths being controlled individually; and
replicating the projected image content using the optical replication component and directing the replicated image content, spatially offset, onto the eye of the user, so that a plurality of mutually spatially offset exit pupils having the image content is produced.

46. The method as recited in claim 45, wherein sub-image data for controlling the projector unit are generated from the image data of the image source, the sub-image data permitting projection of the image content via different imaging paths onto at least one projection region of the diverting unit, and different sub-image data are generated for at least two different respective imaging paths, so that a distortion of the image content is compensated for at least to some extent via the respective imaging path.
